(19) United States
(12) Patent Application Publication
(10) Pub. No.: US 2026/0323793 A1
(43) Pub. Date: Oct. 15, 2026

(54) COOKING APPLIANCE HAVING A DOME FOR DISTANCING A SENSOR DEVICE FROM A MUFFLE

(71) Applicant: BSH Hausgeräte GmbH, Munich (DE)

(72) Inventors: Matthias Vogt, Gundelfingen Donau (DE); Christian Böttcher, Traunstein (DE); Markus Kuchler, Gstadt am Chiemsee (DE); Sebastian Sterz, Großaitingen (DE)

(21) Appl. No.: 19/101,290

(22) PCT Filed: Oct. 4, 2023
(86) PCT No.: PCT/EP2023/077476

§ 371 Date: Feb. 5, 2025

(30) Foreign Application Priority Data
Oct. 23, 2022 (DE) 102022210784.5

(51) Int. Cl. H05B 6/64; H04N 23/50; H04N 23/90; H05B 6/76

(52) U.S. Cl. CPC H05B 6/6426; H04N 23/555; H04N 23/90; H05B 6/76

(57) ABSTRACT

A cooking appliance includes a housing, a muffle having walls to delimit a cooking chamber in the housing, a sensor device designed to monitor a cooking procedure carried out in the cooking chamber, and a dome designed to space the sensor device from an inner side of one of the walls of the muffle. The dome includes a feed opening close to the sensor device and a detection opening close to the cooking chamber. The dome includes a wall which delimits an inner space of the dome and includes a plurality of through-openings. A closure element is movable from a release position, in which a detection path extending from the feed opening to the detection opening is released, into a closed position, wherein when the closure element is moved into the closed position, a heat transfer from the cooking chamber to the sensor device can be reduced.

The invention relates to a cooking appliance having a housing, in which a cooking chamber is formed, wherein the cooking chamber is delimited by walls of a muffle of the cooking appliance. The cooking appliance has at least one sensor device which is designed to monitor a cooking procedure which can be carried out in the cooking chamber. The at least one sensor device is spaced apart from an inner side of a wall of the muffle by means of a dome of the cooking appliance. The dome has a feed opening close to the at least one sensor device and a detection opening close to the cooking chamber. A closure element is movable from a release position into a closed position, wherein in the release position a detection path extending from the feed opening to the detection opening is released. By moving the closure element into the closed position an extent of the heat transfer from the cooking chamber to the at least one sensor device can be reduced.

DE 10 2019 213 485 A1 describes a microwave appliance with a microwave dome, wherein the microwave dome has a first sensor opening and a second sensor opening. Respective sensors are arranged to the rear of the sensor openings. A dome cover which can be moved by a motor is provided for closing a cooking chamber opening of the microwave dome.

It is the object of the present invention to provide a cooking appliance of the type mentioned in the introduction in which it is possible to avoid to a particularly large extent the application of heat to the sensor device.

This object is achieved by a cooking appliance having the features of claim 1. Advantageous embodiments with expedient developments of the invention are specified in the dependent claims and in the following description.

The cooking appliance according to the invention having a housing, in which a cooking chamber is formed that is delimited by walls of a muffle of the cooking appliance, has at least one sensor apparatus which is designed to monitor a cooking procedure which can be carried out in the cooking chamber. The at least one sensor apparatus is spaced apart from an inner side of a wall of the muffle by means of a dome of the cooking appliance. The dome has a feed opening close to the at least one sensor device and a detection opening close to the cooking chamber. The cooking appliance has a closure element which is movable from a release position into a closed position. In the release position, a detection path extending from the feed opening to the detection opening is released. By moving the closure element into the closed position an extent of a heat transfer from the cooking chamber to the at least one sensor device can be reduced. At least one wall of the dome, which delimits an inner space of the dome, has a plurality of through-openings.

During operation of the cooking appliance, i.e. for example during the cooking procedure, the provision of the through-opening in the at least one wall of the dome leads to heat from the cooking chamber being hindered to a particularly large extent from passing to the sensor device due to heat conduction along the wall of the dome which has the through-openings. This is because, due to the through-openings provided in the at least one wall, the path to be covered by the heat during the heat transfer by heat conduction is significantly longer than might be the case with a wall of the dome which is otherwise similar but does not have the through-openings. Thus it is possible to avoid to a particularly large extent an application of heat to the sensor device.

The aim of avoiding a heat transfer to the sensor device is based on the recognition that sensor devices, which can be used for monitoring the cooking procedure which can be carried out in the cooking chamber, are generally sensitive relative to high temperatures. When the sensor device is configured as a camera, for example, this applies to a sensor surface approximately in the shape of a surface of a lens of the camera but also to electronic components integrated in the sensor device which can be configured, in particular, for signal processing. In the case of a sensor device which is configured as an acoustic sensor or as a pressure sensor, heat-sensitive membranes or the like can be present, which have to be protected from the application of heat.

The same applies when the at least one sensor device is configured as a humidity sensor, for example, in which a sensor surface can be configured to be metallic. Here it is a case of avoiding a contact of the sensor surface with, in particular hot, water and/or steam, for example, in order to prevent as far as possible an oxidation of the sensor surface. The avoidance of a transfer of heat to the sensor device is also advantageous in this regard.

In the cooking appliance, the dome firstly ensures that the at least one sensor device is held spaced apart from the inner side of the wall of the muffle. The sensor device does not touch the muffle wall at all, so that a direct conduction of heat from the wall of the muffle into the sensor device is prevented. The provision of the dome also ensures that a heat input into the sensor device due to thermal radiation is negligible. In addition, it is possible to counteract a heat transfer by convection, in particular and very simply by a provision of air flows which can serve for discharging heat from the dome and additionally cooling the sensor device.

Due to the arrangement of the movable closure element on the dome, it is possible to move the closure element out of the release position into the closed position and back again. In the closed position, the closure element, which can also be denoted as a shutter, ensures an additional thermal decoupling of the sensor device from the cooking chamber. This applies to a heat transfer along the dome both via heat radiation and via heat conduction and via convection.

The provision of the through-openings in the at least one wall of the dome also advantageously enables the through-openings to be used for the passage of air, so that firstly a cooling function is achieved and secondly a removal of vapors from the cooking chamber is made possible. This is advantageous.

The provision of the through-openings in the at least one wall of the dome makes it possible, in particular, to use an already existing cool air flow of the cooking appliance for cooling the sensor unit and/or the dome, without a dedicated, separate air duct or air shaft having to be installed in order to conduct the cool air to the dome or away from the dome. Rather, the dome which has the at least one wall with the through-openings can be embedded very easily in a free air flow which can be generated by means of a preferably provided fan of the cooking appliance. If such a fan is used in any case for guiding cool air within the cooking appliance, it can participate in this cool air guidance in order to ensure the cooling of the dome to a sufficient extent as a type of sub-function.

The provision of the through-openings in the at least one wall of the dome makes it particularly simple to integrate the dome into an already existing cooling concept, which contains an air flow which can be provided by means of the preferably provided fan. In particular, it is possible to configure a flushing and/or through flushing of the dome with cool air which is sufficient for cooling and for discharging vapors, but which barely impairs a main air flow of the higher-level cooling concept.

A structure of the dome which is open to the atmosphere is achieved due to the provision of the through-openings in the at least one wall of the dome. This makes it possible to dispense with an installation of air ducts or housings which are complex since they are, for example, pressure-tight or at least sealed. This is because the already existing housing of the higher-level ventilation concept can be advantageously used therewith.

The dome advantageously serves not only as a carrier for the closure element and the spacing of the sensor device from the inner side of the wall of the muffle. Rather, the provision of the through-openings in the at least one wall of the dome ensures a particularly low heat transfer due to heat conduction, i.e. a very low heat dissipation from the cooking chamber.

The dome can be configured in the manner of a protuberance which is configured at least in some regions in the wall of the muffle. Additionally or alternatively, it is possible to configure the dome as a separate component which is connected to the wall of the muffle.

The cooking chamber protuberance or the dome can be advantageously subdivided into two portions by the provision of the closure element, wherein the portions can be separated from one another thermally, i.e. regarding heat radiation, heat conduction and convection, by the closure element being moved into the closed position.

The closure element can be arranged in the region of the feed opening. This has the advantage that a relatively small closure element is sufficient in the dome, which preferably widens from the feed opening to the detection opening. In addition, such a small closure element only needs to be moved along a short displacement path in order to pass from the release position into the closed position. However, with an arrangement of the closure element in the region of the feed opening it is disadvantageous that accumulated heat from the cooking chamber can rise relatively unhindered upwardly into the inner space of the dome and a heat transfer upwardly is only interrupted at the very end by the closure element. Accordingly, a further advantage of an arrangement of the closure element in the region of the feed opening or close to the feed opening can be seen to be that a path is longer for dirt potentially rising from the cooking chamber and thus the closure element is less dirty than might be the case with an arrangement of the closure element closer to the cooking chamber.

Moreover, it is possible to arrange the closure element in the region of the detection opening. This has the advantage that a very effective thermal decoupling of the sensor device can be achieved by moving the closure element into the closed position. However, the arrangement of the closure element in the region of the detection opening with a dome widening toward the cooking chamber is associated with the fact that a surface area of the closure element is relatively large. Accordingly, a significant travel is also required in order to displace or to move the closure element from the release position into the closed position and back again. Moreover, the closure element is more difficult to protect from dirt when the closure element is located very close to the detection opening or in the region of the detection opening.

Preferably, the closure element which is moved into the closed position is arranged spaced apart from the feed opening and from the detection opening in the vertical direction of the dome. Due to such an arrangement of the closure element, two thermal zones can be configured in the dome. A heat transfer by means of heat radiation and convection from the cooking chamber to the feed opening is reduced by the first and relatively hot zone or thermal zone close to the cooking chamber. In addition, a particularly effective active cooling can be achieved in the second zone or thermal zone, or similar portion of the dome, remote from the cooking chamber. This is because only a small amount of heat flows back into this second zone or this second portion. This is because a very effective thermal decoupling of the second zone or the second portion can be achieved by means of the closure element.

Due to the preferably provided reduction of a cross-sectional surface of the dome from the detection opening to the feed opening, i.e. due to the funnel-shaped design of the dome, for example, with the arrangement of the closure element between the feed opening and the detection opening in the vertical direction, it is ensured that the displacement path for moving the closure element from the release position into the closed position and back again is still relatively short. This is advantageous.

By arranging the closure element between the feed opening and the detection opening in the vertical direction of the dome, it can also be achieved that two dome portions can be separately produced and mounted on one another in order to provide the dome, the closure element being arranged therebetween. This advantageously opens up a great freedom of design in the choice of material for the dome portions, in particular the dome halves.

The advantages associated with the arrangement of the closure element spaced apart from the feed opening and from the detection opening apply to a particular extent when the closure element which is moved into the closed position is arranged substantially centrally relative to a spacing of the feed opening from the detection opening.

The vertical direction of the dome can coincide, but does not need to coincide, with a vertical direction of the cooking appliance. Rather, other orientations of a vertical axis of the dome are possible, in particular an oblique orientation of the vertical axis of the dome, which preferably can be oriented toward a central point of the cooking chamber. In particular, when the sensor device is configured as a sensor which is different from a camera, for example as a humidity sensor or the pressure sensor, it is possible to provide relatively significant deviations of an orientation of the vertical axis of the dome from the vertical direction of the cooking appliance without this impairing a detection of variables which can be detected by means of these sensors.

However, even when the sensor device is configured as a camera, it is possible to provide an oblique orientation of the vertical axis or longitudinal axis of the dome relative to the vertical direction of the cooking appliance. For example, the dome can be arranged in the region of a wall of the muffle which is configured, in particular, as a cooking chamber ceiling, such that a viewing direction along the vertical axis of the dome substantially corresponds to a viewing direction of a user of the cooking appliance who looks into the cooking chamber when the door of the cooking appliance is partially opened in order to check the state of food to be cooked which is located in the cooking chamber. Accordingly, the vertical axis of the dome can be oriented slightly obliquely from the cooking chamber ceiling to a cooking chamber central point.

It can be provided that the at least one wall of the dome has the through-openings in a partial region close to the cooking chamber. This is advantageous since a heat conduction is very substantially prevented where particularly high temperatures prevail during the operation of the cooking appliance, i.e. during the cooking procedure carried out in the cooking chamber. Moreover, an active suction of vapors from the cooking chamber via the dome can be achieved by the provision of the through-openings in the partial region close to the cooking chamber.

If the partial region of the dome close to the cooking chamber is embedded in an insulating material which serves for the thermal insulation of the cooking chamber, relatively simple measures can be implemented in order to prevent vapors passing into the insulating material or insulation material via the through-openings.

It can be provided that the at least one wall of the dome has the through-openings in a partial region remote from the cooking chamber. Thus the partial region of the dome remote from the cooking chamber can be flushed with cool air in a very simple manner.

In addition, condensate and/or vapors rising in the inner space of the dome can be discharged via the through-openings which are configured in this partial region, before the condensate and/or the vapors reach the sensor device. This is advantageous.

It has also been shown to be advantageous if the at least one wall of the dome has the through-openings both in the partial region close to the cooking chamber and in the partial region remote from the cooking chamber. Thus it is possible to prevent to a particularly large extent a heat transfer to the sensor device via heat conduction, which takes place in the wall of the dome having the through-openings. In addition, the advantages which have been explained for the configuration of the through-openings in the respective partial region of the wall also apply to this embodiment.

Preferably, the dome has a plurality of walls facing one another. In this case, it can be provided that only one of these walls has the through-openings. In such an embodiment, it can be ensured in a very simple manner that a negative pressure is generated in the inner space of the dome in order to configure in the inner space a directed air flow which can be used for cooling the dome and/or for discharging vapors from the dome.

For example, the Bernoulli effect and/or the principle of the Dorade fan (known per se and thus not explained in detail in the present case) can be used for generating the negative pressure. Additionally or alternatively, a flushing of the inner space of the dome can be achieved by providing an overpressure, for example in order to bring about a cooling of the dome.

Alternatively, it can be provided that when the dome has a plurality of walls facing one another, two of these walls have the through-openings. In such an embodiment, in particular, a through-flow of the dome with cool air in the transverse direction, i.e. transversely to the detection path, can be achieved in a particularly simple manner. Moreover, in particular by such an embodiment it can be ensured in a simple manner that an air flow directed into the cooking chamber is generated in the inner space of the dome by an overpressure in the environment of the dome. Thus it is possible to avoid particularly effectively that vapors pass from the cooking chamber to the sensor device.

In particular with a transverse flushing of the dome with cool air, a flushing of a lens of the camera can be advantageously achieved when the sensor device is configured as a camera. This applies, in particular, when the lens of the camera is not arranged tightly seated on the feed opening but an air gap is configured at this point, i.e. between the lens of the camera and the feed opening. A particularly effective cooling of the camera can be achieved thereby.

Alternatively, all of the walls can have the through-openings when the dome has a plurality of walls facing one another. In this manner, a particularly substantial reduction in the heat conduction can be achieved via the walls of the dome. In addition, in this embodiment a cooling air flow in the inner space of the dome can also be adjusted in a very simple manner. This is due to an improved cooling of the sensor device.

The walls of the dome facing one another can be configured, in particular, as walls of the dome opposing one another transversely to the detection path. In this manner, a flushing of the inner space of the dome can be achieved in a particularly simple manner, in particular in the transverse direction of the dome.

Preferably, the cooking appliance has at least one fan which is designed to provide an air flow in a partial space of the cooking appliance arranged between an outer side of the muffle and an inner side of the housing. A discharge of heat from the dome and/or from the at least one sensor device can be brought about by means of the air flow by operating the at least one fan. Thus it is possible to prevent to a particularly large extent that heat is transmitted from the cooking chamber to the at least one sensor device.

Preferably, a suctioning of air from the inner space of the dome can be brought about by means of the fan. Thus it can firstly be ensured that hot accumulated air is not present in the inner space of the dome, which would lead to an undesired heat transfer to the sensor device. Moreover, in this manner it is possible to achieve a suctioning of vapors from the cooking chamber of the cooking appliance via the dome.

Additionally or alternatively, it can be provided that an introduction of air into the inner space of the dome can be brought about by means of the fan. This is also due to an effective heat discharge from the dome and/or from the sensor device.

Preferably, an introduction of air into the inner space of the dome via the through-openings which are configured in a first wall of the dome and a discharge of the air via the through-openings which are configured in a second wall of the dome can be brought about by means of the fan. In this case, the first wall and the second wall face one another. Thus a transverse flushing of the dome can be advantageously achieved with cool air in the form of the air flow. This is due to an effective cooling of the dome and thus ensures an efficient reduction of the heat transfer to the sensor device.

It can be provided that at least in a partial region of the wall the through-openings are concealed by means of a cover element, wherein the cover element prevents the air flow from passing through these through-openings. In this manner, it is possible to adjust in a very targeted manner which through-openings are intended to serve merely for reducing a heat conduction and which through-openings are intended to be used as air through-openings.

In particular by the provision of the at least one cover element, it can be achieved that no vapors pass via the through-openings into an insulation material or insulating material of the cooking appliance which externally clads the muffle and ensures the thermal insulation of the muffle. Moreover, a desired air flow through the inner space of the dome can be adjusted very effectively and simply by the provision of the at least one cover element.

Preferably, the dome has a first portion close to the cooking chamber and a second portion remote from the cooking chamber. In this case, the at least one wall has a first material in the first portion and a second material, which is different from the first material, in the second portion. Thus it can be achieved very effectively that the materials used in the respective portion are particularly well-suited for their respective purpose.

For example, it is advantageous if the material used in the first portion has a particularly low heat conductivity, in particular a lower heat conductivity than the second material. This is because a heat transfer due to heat conduction via the at least one wall of the dome to the at least one sensor device can be prevented to a particularly large extent.

It can be provided that the cooking appliance has an apparatus for the application of microwaves to the cooking chamber. In this case, it has been shown to be advantageous if the first portion has a metallic and/or electrically conductive nature by which it is possible to prevent an escape of microwaves via the dome into an environment of the first portion. This is because it is possible to ensure in a particularly effective manner that microwave radiation is already reduced in the region of the first portion and thus is retained. In the second portion, the microwave radiation is preferably reduced to a sufficient extent that there is a particularly wide freedom in the choice of the material which is used in the second portion. For example, the second portion can be formed from a ceramic material and/or from a plastic.

The first portion can have the metallic and/or electrically conductive nature, by the first portion being formed from at least one metal. Additionally or alternatively, it is possible that a metallic coating is applied to a main body of the wall. In this case, the metallic coating can be arranged on an inner side of the main body facing the inner space of the dome and/or on an outer side of the main body facing away from the inner space. In all of these cases, the provision of the metallic material or the metallic and/or electrically conductive nature ensures an effective retention of the microwave radiation so that an escape of the microwave radiation from the cooking appliance is prevented.

Even if the cooking appliance does not have an apparatus for the application of microwaves to the cooking chamber, it can be provided that the first portion is formed from a material which has a lower heat conductivity than a material used for the second portion. As a result, a heat conduction to the sensor device is already very substantially reduced in the first portion. In particular, material used in the first portion can be a ceramic material. In particular, when the cooking appliance does not have the apparatus for the application of microwaves to the cooking chamber, the second portion can be formed, in particular, from a plastic, for example from polyphenylene sulfide (PPS). This is because it is advantageous regarding costs and a simple provision of the second portion requiring little effort.

It can be provided that the closure element is movable in a linear manner for moving from the release position into the closed position and back again. In this case, the closure element is accommodated in a pocket-like receiver in the release position. As a result, it is possible to achieve a very effectively guided movement of the closure element from the release position into the closed position and back again.

Alternatively, it can be provided that the closure element is rotatable about an axis of rotation for moving from the release position into the closed position and back again, wherein the closure element in the release position is accommodated in a pocket-like receiver. Such a mobility of the closure element can be implemented in a particularly compact and space-saving manner. Moreover, by providing an electric motor or the like, for example, the rotation of the closure element about the axis of rotation for moving the closure element from the release position into the closed position and back again can be implemented technically very simply.

The pocket-like receiver can be arranged, in particular, on a wall of the dome or configured in the wall of the dome. Thus the closure element can be integrated particularly simply in the dome.

Preferably, the closure element in the closed position shields at least a portion of the dome from the cooking chamber. Thus the extent of the heat transfer from the cooking chamber to the sensor device can be reduced particularly effectively.

It has also been shown as advantageous if the closure element is configured in the manner of a flap which is pivotable about a pivot axis from the release position into the closed position. The flap can be arranged on an inner side of one of the walls of the dome. In this case, in particular by a light-reflecting configuration of at least one side of the closure element, it can be achieved that the sensor device uses this reflective side of the closure element in order to look into the cooking chamber.

In particular with an arrangement of the closure element configured as a flap on the detection opening of the dome, the movement of the closure element from the release position into the closed position and back again can be implemented very simply and with little effort by pivoting the flap about the pivot axis.

When configuring the sensor device as a camera, the cooking procedure carried out in the cooking chamber can be monitored in a particularly simple manner, for example by an image captured by means of the camera being shown on the display device of the cooking appliance. Thus by considering the image a user of the cooking appliance can very simply obtain information about the state of food to be cooked located in the cooking chamber, without the user having to open a door of the cooking appliance, by means of which a loading opening of the muffle is able to be closed.

Preferably, the at least one sensor device comprises a first camera with an image sensor and a second camera with an infrared sensor. In this case, the cooking appliance has a movement device, the first camera or the second camera being able to be selectively or sequentially placed thereby on the feed opening. A thermal image of the cooking chamber can be created and, in particular, displayed to the user by means of the second camera having the infrared sensor, which permits very clear conclusions to be made about the state of the food to be cooked in the cooking chamber. In addition, the images from the food to be cooked can be captured by means of the first camera having the image sensor, the images being able to be displayed to the user by means of the display device. This is advantageous.

Additionally or alternatively, the data of a control device of the cooking appliance detected by the first camera and by the second camera can be supplied to a control device of the cooking appliance, the cooking procedure of the food to be cooked being able to be particularly easily controlled thereby. This is because an automatic monitoring of the cooking procedure can be implemented very simply by means of the control device by evaluating the data detected by means of the first camera and the second camera. This makes the preparation of food to be cooked particularly easy and convenient for the user of the cooking appliance.

Preferably, the cooking appliance has a control device which is designed to bring about a movement of the closure element from the closed position into the release position and back again, as a function of switching on the cooking appliance and/or as a function of terminating the cooking procedure.

This is based on the recognition that the closure element can become dirty during the operation of the cooking appliance. This is because, among other things, one of the tasks of the closure element in the closed position is to protect the sensor device from being subjected to dirt. By a movement of the closure element undertaken from time to time from the release position into the closed position and back again, a smooth operation of the closure element can be ensured during such movements. In addition, optionally deposits or dirt collected on the closure element can be wiped off or pushed into regions where they are not a nuisance. In particular, a cleaning of the closure element can be achieved in this manner.

It is particularly simple if such a cleaning movement is undertaken when the cooking appliance is switched on, in particular each time the cooking appliance is switched on and/or after the cooking procedure is terminated, in particular each time after the cooking procedure is terminated. This is because a regular movement of the closure element can be ensured in this manner.

Positions and orientations provided when the cooking appliance is used as intended and arranged as intended and when an observer is standing, in particular, in front of the cooking appliance and is looking in the direction of the cooking appliance, are specified by the terms such as “above”, “below”, “front”, “rear”, “horizontal”, “vertical”, “depth direction”, “width direction”, “vertical direction” and the like.

The features and combinations of features mentioned above in the description and the features and combinations of features mentioned hereinafter in the description of the figures and/or shown individually in the figures are not only able to be used in the respectively specified combination but also in other combinations or individually, without departing from the scope of the invention. Thus embodiments which are not explicitly shown or explained in the figures, but which are revealed and can be generated by separate combinations of features from the explained embodiments, are to be also regarded as encompassed and disclosed by the invention. Thus embodiments and combinations of features which do not have all of the features of an originally formulated independent claim are to be regarded as disclosed. Moreover, embodiments and combinations of features which go beyond the combinations of features set forth in the references of the claims or which deviate therefrom are to be regarded as disclosed, in particular by the embodiments set forth above.

Further advantages, features and details of the invention are found in the claims, the following description of preferred embodiments and by way of the drawings, in which:

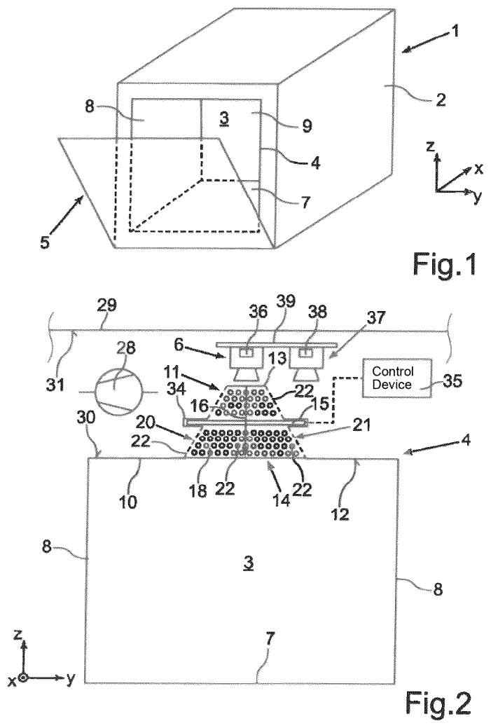

FIG. 1 shows highly schematically a cooking appliance in a perspective view;

FIG. 2 shows schematically the arrangement of a dome of the cooking appliance in the region of a ceiling wall of a muffle of the cooking appliance according to FIG. 1;

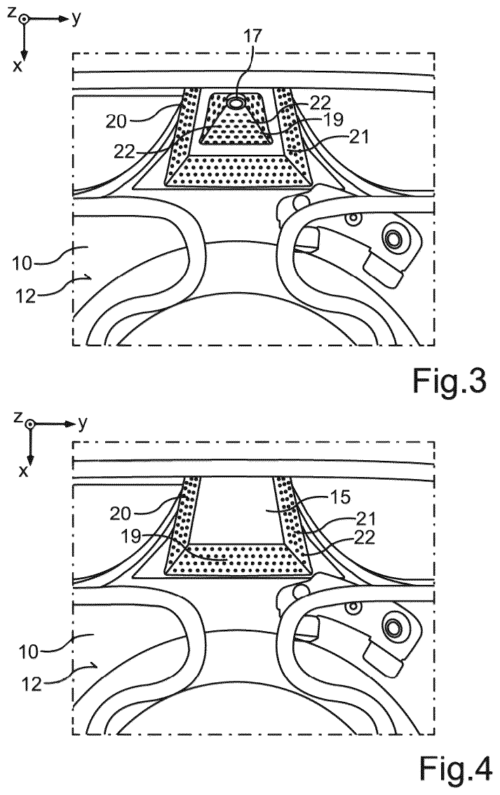

FIG. 3 shows the dome according to FIG. 2 in a view from the cooking chamber, wherein a closure element is moved into a release position;

FIG. 4 shows the dome according to FIG. 2 in a view from the cooking chamber, wherein the closure element is moved into a closed position;

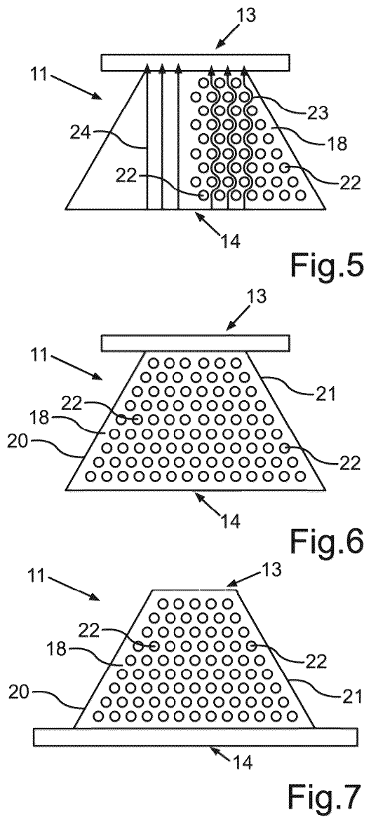

FIG. 5 shows schematically the effect of the provision of a plurality of holes or similar through-openings in a wall of the dome;

FIG. 6 shows schematically the arrangement of the closure element on an upper end of the dome;

FIG. 7 shows schematically the arrangement of the closure element on a lower end of the dome;

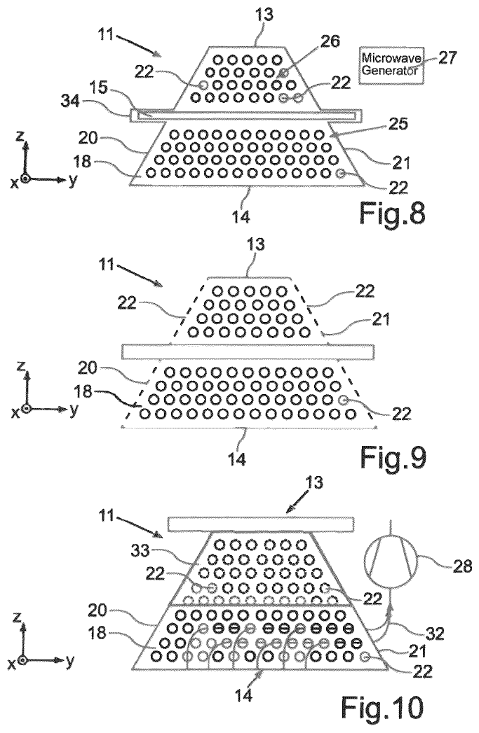

FIG. 8 shows schematically a substantially central arrangement of the closure element on the dome;

FIG. 9 shows schematically the configuration of through-openings or holes in all of the walls of the dome;

FIG. 10 shows schematically the suctioning of vapors from a partial region of the dome by means of a fan of the cooking appliance;

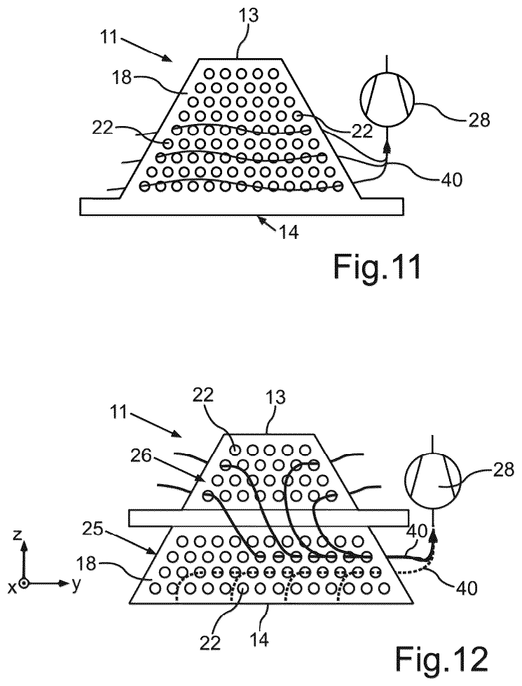

FIG. 11 shows schematically the adjustment of a throughflow of the dome with cool air, wherein the throughflow is brought about by means of the fan of the cooking appliance; and

FIG. 12 shows schematically a combination of suctioning hot air and vapors from the dome and a throughflow of the dome with cool air in different levels or portions of the dome.

Elements which are identical or functionally equivalent are provided in the figures with identical reference signs.

A household appliance in the form of a cooking appliance 1, which has a housing 2 or external housing which is configured to be substantially cuboidal, is shown highly schematically in FIG. 1. A cooking chamber 3 is configured in the cooking appliance 1, wherein the cooking chamber 3 is delimited by walls of a muffle 4 of the cooking appliance 1. A front-side loading opening of the muffle 4 is able to be closed by means of a door 5 of the cooking appliance 1, which is shown partially open in FIG. 1. According to FIG. 1, when viewed together with FIG. 2, the walls of the muffle 4 comprise a bottom 7, two opposing side walls 8, a rear wall 9 and a ceiling wall 10.

The cooking appliance 1 has at least one sensor device for monitoring a cooking procedure which can be carried out in the cooking chamber 3. A first camera 6 which is designed to capture images from food to be cooked which is located in the cooking chamber 3 during a cooking procedure is shown as an example of such a sensor device in FIG. 2. The cooking appliance 1 has a dome 11 in order to prevent as far as possible an application of heat from the cooking chamber 3 to the sensor device, thus in the present case the camera 6 for example. The dome 11 ensures that the camera 6 is spaced apart from an inner side 12 of one of the walls of the muffle 4, for example from the inner side 12 of the ceiling wall 10.

It is shown schematically and by way of example in FIG. 2 that the dome 11 is arranged in the region of the ceiling wall 10, so that the camera 6 can look into the cooking chamber 3 from above. The dome 11 has a feed opening 13 close to the camera 6 and a detection opening 14 close to the cooking chamber. In the present case, the dome 11 extends from the feed opening 13 to the detection opening 14. In particular, the dome 11 can be configured in the manner of a truncated pyramid, as shown by way of example in the present case, wherein the feed opening 13 and the detection opening 14 can be configured in a rectangular, in particular square, manner.

A closure element 15 which is moved into a closed position is shown schematically in FIG. 2. In the closed position, the closure element 15 blocks a detection path 16 which extends from the feed opening 13 to the detection opening 14. Along this detection path 16 the camera 6 can look into the cooking chamber 3 or capture images from the food to be cooked (not shown in the present case) which is located in the cooking chamber 3.

If the closure element 15 is moved into a release position (see FIG. 3) the detection path 16 is released. Accordingly a lens 17 of the camera 6 facing the cooking chamber 3 can be seen in FIG. 3. If the closure element 15 is correspondingly moved into a closed position (see FIG. 4), the closure element 15 effectively prevents a heat transfer from the cooking chamber 3 to the camera 6. By moving the closure element 15 into the closed position (see FIG. 4), therefore, an effective thermal decoupling of the camera 6 from the heat of the cooking chamber 3 is ensured.

In the present case, this thermal decoupling is further improved by a plurality of through-openings 22 being configured in at least one wall 18, 19, 20, 21 of the dome 11. In the present case, a left-hand wall 20 in the transverse direction y of the cooking chamber 3 and the cooking appliance 1 and the opposing right-hand wall 21 of the four walls 18, 19, 20, 21 of the dome 11 can be seen in FIG. 2. These opposing walls 20, 21 of the dome 11 can also be identified in FIG. 3 and FIG. 4.

The front wall 18 of the dome 11 in the depth direction x of the cooking appliance 1 and the cooking chamber 3 can also be seen in FIG. 2, while the rear wall 19 of the dome 11 in the depth direction x of the cooking appliance 1 and of the cooking chamber 3 can be identified in FIG. 3 and in FIG. 4. The transverse direction y, the depth direction x and a vertical direction z of the cooking appliance 1 and the cooking chamber 3 are illustrated, for example, by a respective coordinate system in FIG. 1 and FIG. 2.

Only some of the through-openings 22 are provided with a reference sign in the figures for reasons of clarity. In particular, it can be illustrated by way of FIG. 5 how the heat conduction from the detection opening 14 to the feed opening 13 is reduced due to the provision of the through-openings 22 in at least one of the walls 18, 19, 20, 21 of the dome 11, for example in the front wall 18 of the dome 11 shown in FIG. 5. This is because a path 23, along which the heat passes from the detection opening 14 to the feed opening 13 due to heat conduction, is longer than a straight path 24, also shown in FIG. 5, due to the provision of the through-openings 22.

A variant of the dome 11 in which the closure element 15 is arranged substantially equally spaced apart from the feed opening 13 and from the detection opening 14 in the vertical direction z of the dome 11 is shown in FIG. 2. Accordingly, a variant of the dome 11 in which the closure element 15 is arranged at an upper end of the dome 11 in the vertical direction z, i.e. in the region of the feed opening 13 of the dome 11, is shown in FIG. 6. In addition, in the variant of the dome 11 according to FIG. 7 the closure element 15 is arranged at the bottom in the vertical direction z of the dome 11, i.e. in the region of the detection opening 14.

Due to the design of the dome 11 widening in the present case from the feed opening 13 to the detection opening 14, the arrangement of the closure element 15 at the top (see FIG. 6) has the advantage that a travel or displacement path for moving the closure element 15 is thus particularly short. Moreover, the closure element 15 is less dirty since the path from the detection opening 14 to the closure element 15 is longer than in the variant shown in FIG. 2 and FIG. 7 of the arrangement of the closure element 15.

Accordingly, the variant of the dome 11 shown in FIG. 7 has the advantage that the closure element 15 ensures a particularly good thermal decoupling. However, the closure element 15 has to be configured with a larger surface area and also the displacement path or the travel of the closure element 15 is longer than in the variant of the dome 11 shown in FIG. 6.

The arrangement of the closure element 15 which is spaced apart both from the feed opening 13 and from the detection opening 14, in particular the central arrangement of the closure element 15 shown in FIG. 2, makes it possible to combine to a particularly large extent the respective advantages of the variants shown in FIG. 6 and in FIG. 7.

In the substantially central arrangement of the closure element 15, shown schematically in FIG. 8, there is also the possibility of configuring the respective portions 25, 26 of the dome 11 from different materials which are in each case particularly well-suited. For example, the dome 11 according to FIG. 8 can have a first portion 25 close to the cooking chamber 3 and a second portion 26 remote from the cooking chamber 3.

If the cooking appliance 1 has a microwave generator 27, shown schematically in FIG. 8, it is advantageous in the present lower portion 25, i.e. for example in the lower dome half, to configure the walls 18, 19, 20, 21 to be metallic or to provide at least one metallic surface or coating of a main body of the respective wall 18, 19, 20, 21. This is because in the first portion 25 microwave radiation can be retained particularly effectively. There is a great freedom in the choice of material in the upper dome half or in the second portion 26, since the microwave radiation is reduced to a sufficient extent in the first portion 25.

If accordingly the cooking appliance 1 does not have the microwave generator 27, shown schematically in FIG. 8, or such an apparatus for the application of microwaves to the cooking chamber 3, for example, the first portion 25 can be formed from a poor heat-conducting material, such as for example a ceramic material. Accordingly, the second portion 26 of the dome 11 can be formed, for example, from a metal or from a plastic, wherein the latter is advantageous, in particular, for cost reasons.

It can be provided that the closure element 15 can be moved in a linear manner in order to move the closure element 15 from the release position (see FIG. 3) into the closed position (see FIG. 4) and back again. Alternatively, it is possible that the closure element 15 is rotatable, for example, about an axis of rotation oriented substantially parallel to the vertical direction z or vertical axis or longitudinal axis of the dome 11 (see FIG. 8) in order to move the closure element 15 from the release position into the closed position and back again. Such a rotational movement of the closure element 15 about the axis of rotation can be implemented particularly simply by means of an actuator, such as an electric motor for example.

The through-openings 22 or holes in the at least one wall 18, 19, 20, 21 of the dome 11 can be configured, for example, only in the first portion 25 or only in the second portion 26. Moreover, it is possible to provide the through-openings 22 both below and above the parting plane of the dome 11 provided by the closure element 15 according to FIG. 8, as shown by way of example and schematically in FIG. 8.

Moreover, the through-openings 22 can be configured in only one of the walls 18, 19, 20, 21 or, for example, in two opposing walls 20, 21 or in all four walls 18, 19, 20, 21 of the dome 11. The latter is illustrated schematically in FIG. 9. Accordingly in the view of the dome 11 shown schematically in FIG. 8, the two walls 20, 21 of the dome 11 which oppose one another in the transverse direction y of the dome 11 are not provided with the through-openings 22 or holes, but for example only the front wall 18 in the depth direction x and/or the rear wall 19 in the depth direction x which cannot be seen in FIG. 8.

Different ventilation concepts can be implemented depending on which of the walls 18, 19, 20, 21 are provided with the through-openings 22. This is to be explained, in particular, with reference to FIG. 10 to FIG. 12.

According to FIG. 2 the cooking appliance 1 in the present case has at least one fan 28 which is shown in FIG. 2 only schematically and not realistically in terms of the actual arrangement inside the housing 2. In FIG. 2 only one upper housing wall 29 of the housing 2 of the cooking appliance 1 is shown schematically and in detail. The fan 28 can be arranged, in particular, in a partial space of the cooking appliance 1 which is configured between an outer side 30 of the muffle 4 and an inner side 31 of the housing 2 (see FIG. 2). During operation, the fan 28 can provide an air flow, for example, to ventilate around the door 5 of the cooking appliance 1 and/or in order to discharge vapors from the cooking chamber 3 of the cooking appliance 1. The air flow, which is provided in any case by the fan 28, in the present case is preferably used in order to cool the at least one sensor device, i.e. for example the camera 6, and in order to discharge heat and/or vapors from the region of the dome 11.

For example, an operation of the fan 28 is illustrated in FIG. 10 in which the fan 28 suctions vapors and/or hot accumulated air from the inner space of the dome 11. Here the air flow or the air suctioned via the through-openings 22 from the dome 11 is illustrated by flow lines 32.

In particular, in order to implement a suctioning from a specific region of the dome 11, at least one partial region of the at least one wall 18, 19, 20, 21 of the dome 11 can be concealed by means of a cover element 33 which is only shown schematically in FIG. 10. The cover element 33 can be formed, for example, from a plastic.

In spite of the provision of the cover element 33, the through-openings 22 which are configured in the at least one wall 18, 19, 20, 21 of the dome 11 ensure a reduction of the heat conduction from the detection opening 14 of the dome 11 to the feed opening 13 of the dome 11. The cover element 33 ensures, in particular, that the uncovered through-openings 22 are additionally effective as air through-openings, while all of the through-openings 22 prevent the heat conduction.

In the dome 11, shown schematically in FIG. 10, the closure element 15 is arranged in the region of the feed opening 13, as shown in FIG. 6. However, in this variant and as shown in FIG. 7 or for example in FIG. 8 and in FIG. 9, the closure element 15 can also be arranged spaced apart from the feed opening 13 and from the detection opening 14 in the vertical direction z of the dome 11.

It can also be seen from FIG. 2 and, for example, from FIG. 8 that the dome 11 for accommodating the closure element 15 has a pocket-like receiver 34 which can be integrated, for example, in at least one of the walls 18, 19, 20, 21 of the dome 11. The closure element 15 is moved from this pocket-like receiver 34 into the closed position, shown for example in FIG. 2 and in FIG. 4 or in FIG. 8. In order to bring about the movement of the closure element 15 into the release position and the closed position and back again, the cooking appliance 1 can have a control device 35 or similar control appliance, wherein the control device 35 is shown highly schematically in FIG. 2.

It can also be seen from FIG. 2 that the at least one sensor device of the cooking appliance 1 can comprise the camera 6, which has an image sensor 36. By means of this (optical) camera 6, images can be accordingly captured from the food to be cooked which is located in the cooking chamber 3. Moreover, the sensor device of the cooking appliance 1 can comprise a second camera 37 which is configured as an infrared camera and thus has an infrared sensor 38. A movement device 39 of the cooking appliance 1 is shown schematically in FIG. 2, the first camera 6 or the second camera 37 being able to be selectively or sequentially placed thereby on the feed opening 13 of the dome 11.

During the operation of the fan 28, shown schematically in FIG. 11, it can be ensured that the inner space of the dome 11 is transversely flushed with cool air, for example in order to achieve a cooling of the dome 11. Here, as in FIG. 12, the corresponding air flow is illustrated by flow lines 40.

A mode of operation of the fan 28 is illustrated schematically in FIG. 12, in which the fan 28, on the one hand, ensures in the lower portion 25 of the dome 11 a suctioning of hot air and/or vapors from the cooking chamber 3. At the same time, the fan 28 brings about a flow of cool air through the dome 11, in particular through the upper portion 26 of the dome 11.

Such a flow guidance or air flow can be achieved, for example, by the dome 11 being arranged in the partial space between the inner side 31 of the housing 2 and the outer side 30 of the muffle 4, in particular between the inner side 31 of the upper housing wall 29 of the housing 2 and the outer side 30 of the ceiling wall 10 of the muffle 4 (see FIG. 2), such that the lower portion 25 of the dome 11 in the vertical direction z of the dome 11 is influenced by a suction side of the fan 28, while the upper portion 26 of the dome 11 is subjected to the air coming from a pressure side of the fan 28.

Advantageously, it can be provided in the cooking appliance 1, in particular, that the cool air flow, which is present in any case in the partial space of the cooking appliance 1 during the operation of the fan 28, is used in order to bring about a corresponding forced movement of the air flow in the region of the dome 11 at the same time. For example, local negative pressure fields can be generated via the Bernoulli effect in the region of the dome 11 so that a suction of air takes place. Additionally or alternatively, actively blowing onto the dome 11 can lead to a flow through the dome 11 due to an overpressure.

Accordingly, there is the possibility, in particular, of bringing about both the cooling of the dome 11 and the at least one sensor device, for example in the form of the first camera 6 and/or the second camera 37, and the removal of vapors from the cooking chamber 3 by participating in a higher-level flow system of the cooking appliance 1 which is generated by the fan 28.

Overall, the examples show how it is possible to provide an improved cooling of a sensor carrier unit, which is provided by the dome 11, of the household appliance which is designed in the present case as a cooking appliance 1.

### LIST OF REFERENCE SIGNS

1 Cooking appliance
2 Housing
3 Cooking chamber
4 Muffle
5 Door
6 Camera
7 Bottom
8 Side wall
9 Rear wall
10 Ceiling wall
11 Dome
12 Inner side
13 Feed opening
14 Detection opening
15 Closure element
16 Detection path
17 Lens
18 Wall
19 Wall
20 Wall
21 Wall
22 Through-opening
23 Path
24 Path
25 Portion
26 Portion
27 Microwave generator
28 Fan
29 Housing wall
30 Outer side
31 Inner side
32 Flow line
33 Cover element
34 Receiver
35 Control device
36 Image sensor
37 Camera
38 Infrared sensor
39 Movement device
40 Flow line
x Depth direction
y Transverse direction
z Vertical direction

1-13. (canceled)

14. A cooking appliance, comprising:
a housing;
a muffle having walls to delimit a cooking chamber in the housing;
a sensor device designed to monitor a cooking procedure carried out in the cooking chamber;
a dome designed to space the sensor device from an inner side of one of the walls of the muffle, said dome including a feed opening close to the sensor device and a detection opening close to the cooking chamber, said dome including a wall which delimits an inner space of the dome and includes a plurality of through-openings; and
a closure element movable from a release position, in which a detection path extending from the feed opening to the detection opening is released, into a closed position, wherein when the closure element is moved into the closed position, a heat transfer from the cooking chamber to the sensor device is reducible.

15. The cooking appliance of claim 14, wherein the closure element is arranged spaced apart from the feed opening and from the detection opening in a vertical direction of the dome, when the closure element is moved into the closed position.

16. The cooking appliance of claim 14, wherein the closure element is arranged substantially centrally relative to a spacing of the feed opening from the detection opening.

17. The cooking appliance of claim 14, wherein the wall of the dome includes the plurality of through-openings in a partial region close to the cooking chamber and/or in a partial region remote from the cooking chamber.

18. The cooking appliance of claim 14, wherein the dome includes a plurality of walls facing one another, wherein only one of the walls is the wall that delimits the inner space of the dome and includes the plurality of through-openings or two of the walls include through-openings of the plurality of through-openings or all of the walls include through-openings of the plurality of through-openings.

19. The cooking appliance of claim 18, wherein the walls of the dome oppose one another transversely to the detection path.

20. The cooking appliance of claim 14, further comprising a fan designed to provide an air flow in a partial space between an outer side of the muffle and an inner side of the housing, with the air flow effecting a discharge of heat from the dome and/or from the sensor device, when the fan is operated.

21. The cooking appliance of claim 20, wherein the fan is designed to suck air from the inner space of the dome and/or to introduce air into the inner space of the dome.

22. The cooking appliance of claim 20, wherein the dome includes a plurality of walls facing one another, said fan being designed to introduce air into the inner space of the dome via through-openings configured in a first one of the walls of the dome and to discharge air via through-openings configured in a second one of the walls of the dome, wherein the first one of the walls and the second one of the walls face one another.

23. The cooking appliance of claim 20, further comprising a cover element designed to conceal at least in a partial region of the wall the through-openings so as to prevent the air flow from passing through the through-openings.

24. The cooking appliance of claim 14, wherein the dome includes a first portion close to the cooking chamber and a second portion remote from the cooking chamber, said wall having a first material in the first portion and a second material in the second portion, with the second material being different from the first material,.

25. The cooking appliance of claim 24, further comprising an apparatus for application of microwaves to the cooking chamber, wherein the first portion has a metallic and/or electrically conductive nature to prevent an escape of microwaves via the dome into an environment of the first portion.

26. The cooking appliance of claim 24, wherein the first portion is formed from a ceramic material which has a heat conductivity which is lower than a heat conductivity of a material used for the second portion.

27. The cooking appliance of claim 14, wherein the closure element is movable in a linear manner from the release position into the closed position or is rotatable about an axis of rotation, the cooking appliance further comprising a pocket-like receiver designed to accommodate the closure element in the release position, said closure element shielding at least a portion of the dome from the cooking chamber in the closed position.

28. The cooking appliance of claim 27, wherein the receiver is arranged on a wall of the dome.

29. The cooking appliance of claim 14, wherein the sensor device comprises a first camera with an image sensor and a second camera with an infrared sensor, the cooking appliance further comprising a movement device designed to selectively or sequentially place the first camera or the second camera on the feed opening.

30. The cooking appliance of claim 14, further comprising a control device designed to bring about a movement of the closure element from the closed position into the release position and back again, as a function of switching on the cooking appliance and/or terminating the cooking procedure.
